(19) United States
(12) Patent Application Publication
(10) Pub. No.: US 2010/0321418 A1
(43) Pub. Date: Dec. 23, 2010

(54) ILLUMINATING DEVICE AND DISPLAY DEVICE

(75) Inventor: Keiji Hayashi, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/866,749

(22) PCT Filed: Jan. 8, 2009
(86) PCT No.: PCT/JP2009/050108

§ 371 Date: Aug. 9, 2010

(30) Foreign Application Priority Data
Apr. 2, 2008 (JP) 2008-095714

(51) Int. Cl. G09G 5/10; F21V 9/00; H05B 37/02; G02F 1/13357

(52) U.S. Cl. 345/690; 362/231; 315/294; 362/97.1

(57) ABSTRACT

Provided is an illuminating device which is capable of suppressing occurrence of irregular color in illuminating light. The illuminating device is provided with a light source substrate (4) and light-emitting devices (7a) which are provided on the front surface of the light source substrate (4) and emit light wherein blue light and fluorescent light are color-mixed with each other. On the front surface of the light source substrate (4), light-emitting devices (7b) which emit blue light are further provided. The light-emitting devices (7a) and the light-emitting devices (7b) are arranged so that the colors emitted respectively therefrom are color-mixed with each other.

### TECHNICAL FIELD

The present invention relates to an illuminating device and a display device.

### BACKGROUND ART

Conventionally, an illuminating device that uses a light-emitting device including a light-emitting diode element as a light source is known and is used as a backlight unit for display devices such as a liquid crystal display device and the like (e.g., see a patent document 1).

FIG. 9 is a diagram simply showing an example of a conventional backlight unit. Hereinafter, the conventional backlight unit is described with reference to FIG. 9.

As shown in FIG. 9, the conventional backlight unit includes at least: a light source substrate 101 that is housed in a backlight chassis; an optical sheet (a sheet that performs diffusion of light and the like) 102 disposed in a region that faces a predetermined surface of the light source substrate 101. And, a plurality of light-emitting devices 104 that serve as light sources 103 are mounted on the predetermined surface of the light source substrate 101.

Each of the plurality of light-emitting devices 104 as the light source 103 includes a blue-light emitting diode element that emits blue light; and converts the blue light from the blue-light emitting diode element into white light. Specifically, each of the plurality of light-emitting devices 104, besides the blue-light emitting diode element, further includes a fluorescent material that is excited by the blue light to emit yellow fluorescence and has a structure in which the blue-light emitting diode element is covered by a seal member that contains the fluorescent material. Because of this, if the blue-light emitting diode element of the light-emitting device 104 is driven, the blue light and the yellow fluorescence are generated and white light obtained by the color mixing of the blue light and the yellow fluorescence is emitted from the light-emitting device 104.

Patent document 1: JP-A-2007-256874

### DISCLOSURE OF THE INVENTION

### Problems to be Solved by the Invention

However, in the conventional backlight unit that uses the plurality of light-emitting devices 104 each having the above structure as the light source 103, it is hard to even the contained amount and distribution of the fluorescent material contained in the seal member of each of the plurality of light-emitting devices 104; and the contained amount and distribution of the fluorescent material become uneven among the plurality of light-emitting devices 104. In other words, the chromaticity of light emitted from each of the plurality of light-emitting devices 104 becomes uneven among the plurality of light-emitting devices 104. In this case, for example, there are disadvantages that light emitted from a predetermined region of the backlight unit become bluish white light; and light emitted from another region becomes yellowish white light. As a result of this, there is a problem that color unevenness occurs in the illuminating light (white light) from the backlight unit.

Here, conventionally, as the light source of the backlight unit, there is a light source that uses a combination of three kinds of light-emitting diode elements, that is, a red-light emitting diode element, a green-light emitting diode element, and a blue-light emitting diode element, thereby obtaining white light. However, in this case, because it is necessary to prepare the three kinds of light-emitting diode elements, there is a disadvantage that the production cost increases.

The present invention has been made to solve the above problems, and it is an object of the present invention to provide an illuminating device and a display device that are able to prevent color unevenness from occurring in the illuminating light (white light).

### Means for Solving the Problem

To achieve the above object, an illuminating device according to a first aspect of the present invention includes: a support member; and a first light-emitting device that is disposed on a predetermined surface of the support member, includes a blue-light emitting diode element that emits blue light, and a fluorescent material that absorbs the blue light and emits fluorescence, and emits color-mixed light of the blue light and the fluorescence. And, besides the first light-emitting device, a second light-emitting device that emits blue light is disposed on the predetermined surface of the support member; and the first light-emitting device and the second light-emitting device are disposed in such a way that the light emitted from the first light-emitting device and the light emitted from the second light-emitting device color-mix with each other. Here, the blue in the present invention is one of three kinds of color obtained by roughly sorting visible light into the three kinds of color and is a general term of the color that includes purple, indigo blue and the like. In other words, the blue is a visible-light color that has a wavelength of 380 nm or longer to 500 nm or shorter.

In the illuminating device according to the first aspect, as described above, the first light-emitting device (which emits the color-mixed light of the blue light and the fluorescence) and the second light-emitting device (which emits the blue light) are disposed on the predetermined surface of the support member; the first light-emitting device and the second light-emitting device are disposed in such a way that both light respectively emitted from the devices color-mix with each other; in an illumination operation, the light (color-mixed light of the blue light and the fluorescence) emitted from the first light-emitting device color-mixes with the light (blue light) emitted from the second light-emitting device, so that both light respectively emitted from the first light-emitting device and the second light-emitting device color-mix with each other; and the color-mixed light serves as the illuminating light. In this case, if the light amounts respectively emitted from the first light-emitting device and the second light-emitting device are separately adjusted, it is possible to turn the illuminating light (color-mixed light of both light respectively emitted from the first light-emitting device and the second light-emitting device) from the illuminating device into white color of a desired chromaticity. As a result of this, it becomes possible to prevent color unevenness from occurring in the illuminating light (white light) from the illuminating device.

Besides, in the illuminating device according to the first aspect, because it is not necessary to use a red-light emitting diode element and a green-light emitting diode element, it is also possible to prevent a disadvantage that the production cost increases from occurring.

In the illuminating device according to the first aspect, preferably, the second light-emitting device is disposed close to each of a plurality of the first light-emitting devices. According to this structure, in a case where a plurality of the first light-emitting devices are disposed, it is possible to surely make both light respectively emitted from the first light-emitting device and the second light-emitting device color-mix with each other.

In the illuminating device according to the first aspect, preferably, the second light-emitting device includes a blue-light emitting diode element that has the same structure as the blue-light emitting diode element of the first light-emitting device and emits blue light generated by the blue-light emitting diode element. According to this structure, even if the two kinds of light-emitting devices (first light-emitting device and second light-emitting device) are used, because the blue-light emitting diode elements respectively mounted in the first light-emitting device and the second light-emitting device are the same as each other, it is possible to further prevent the production cost from increasing.

In this case, it is preferable that the second light-emitting device is disposed at a ratio of one second light-emitting device to two first light-emitting devices. According to this structure, it is possible to improve the balance between the light amounts respectively emitted from the first light-emitting device and the second light-emitting device.

In the illuminating device according to the first aspect, it is preferable that the light amounts respectively emitted from the first light-emitting device and the second light-emitting device are adjusted separately from each other.

In this case, preferably, a first electric-power supply portion that supplies electric power to the first light-emitting device and a second electric-power supply portion that supplies electric power to the second light-emitting device are further included; and respective output electric powers from the first electric-power supply portion and the second electric-power supply portion are adjusted separately from each other. According to this structure, it is possible to easily adjust the light amounts respectively emitted from the first light-emitting device and the second light-emitting device separately from each other.

In the structure further including the first electric-power supply portion and the second electric-power supply portion, preferably, a light-amount detection portion that detects a light amount emitted from each of the first light-emitting device and the second light-emitting device is further included; and based on a detection result in the light-amount detection portion, the respective light amounts from the first electric-power supply portion and the second electric-power supply portion are separately adjusted. According to this structure, even if the chromaticity of the light emitted from each of the first light-emitting device and the second light-emitting device changes with time, in accordance with the change, it is possible to adjust the light amounts respectively emitted from the first light-emitting device and the second light-emitting device separately from each other. Accordingly, it becomes possible to perform a strict light-amount adjustment.

Besides, a display device according to a second aspect of the present invention includes: the illuminating device described in any one of claims 1 to 7; and a display panel which is irradiated with light emitted from the illuminating device. According to this structure, it is possible to easily prevent color unevenness from occurring in the illuminating light (white light) with which the display panel is irradiated.

### ADVANTAGES OF THE INVENTION

As described above, it is possible to easily obtain an illuminating device and a display device that are able to prevent color unevenness from occurring in the illuminating light (white light).

### BRIEF DESCRIPTION OF THE DRAWINGS

FIG. 1 is an exploded perspective view of a liquid crystal display device in which a backlight unit according to a first embodiment of the present invention is disposed.

FIG. 2 is a sectional view of a light-emitting device that is used in the backlight unit according to the first embodiment shown in FIG. 1.

FIG. 3 is a sectional view of a light-emitting device that is used in the backlight unit according to the first embodiment shown in FIG. 1.

FIG. 4 is a diagram for describing a state of light emitted from a light-emitting device used in the backlight unit according to the first embodiment shown in FIG. 1.

FIG. 5 is a diagram of a light-source drive portion of the backlight unit according the first embodiment shown in FIG. 1.

FIG. 6 is a diagram of a light-source drive portion of a backlight unit according to a second embodiment of the present invention. FIG. 7 is a diagram of a light-amount detection portion (light-receiving portion) of light-source drive portion of the backlight unit according to the second embodiment shown in FIG. 6.

FIG. 8 is a diagram of a light-source drive portion of a backlight unit according to a third embodiment of the present invention.

FIG. 9 is a diagram simply showing an example of a conventional backlight unit.

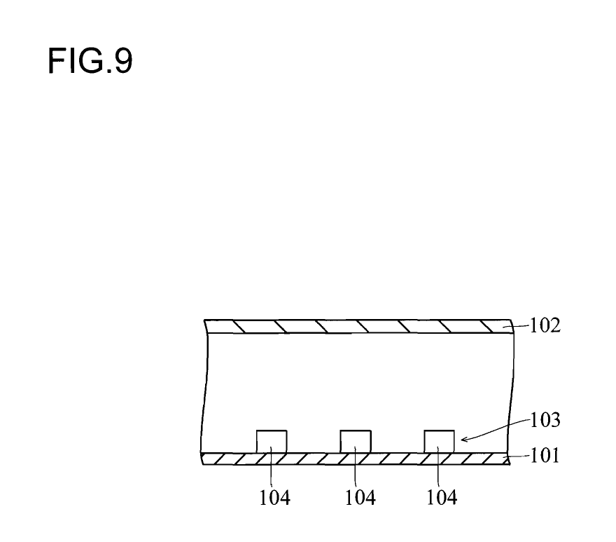

### LIST OF REFERENCE SYMBOLS

1 backlight unit (illuminating device)

2 liquid crystal display panel (display panel)

4 light source substrate (support member)

7a light-emitting device (first light-emitting device)

7b light-emitting device (second light-emitting device)

11 blue-light emitting diode element

12 fluorescent material

20a electric-power supply portion (first electric-power supply portion)

20b electric-power supply portion (second electric-power supply portion)

31 light-amount detection portion

### BEST MODE FOR CARRYING OUT THE INVENTION

### First Embodiment

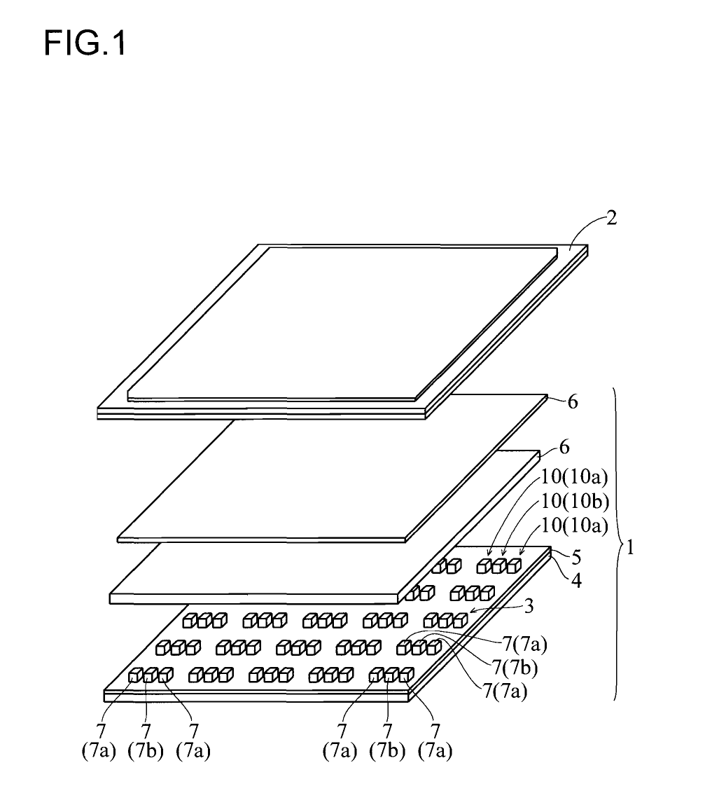

First, a backlight unit according the first embodiment and a liquid crystal display device in which the backlight unit is disposed are described with reference to FIGS. 1 to 5.

In a liquid crystal display device (display device) in which a backlight unit 1 according to the first embodiment is disposed, as shown in FIG. 1, the backlight unit 1 is disposed behind the liquid crystal display panel 2. And, a rear surface of the liquid crystal display panel 2 is irradiated with light (surface light) emitted from the backlight unit 1, so that an image is displayed on a display surface (front surface) of the liquid crystal display panel 2. Here, the backlight unit 1 is an example of an “illuminating device” in the present invention; and the liquid crystal display panel 2 is an example of a “display panel” in the present invention. Hereinafter, a structure of the backlight unit 1 according to the first embodiment is described in detail.

The backlight unit 1 according to the first embodiment is a direct-type backlight unit and a light source 3 is disposed right under the liquid crystal display panel 2. Besides, the light source 3 of the backlight unit 1 is mounted on a front surface of the light source substrate 4 that is housed in a backlight chassis (not shown) in such a way that the light-emitting surface faces the front side. The light source substrate 4 is an example of a “support member” in the present invention and the front surface is an example of a “predetermined surface” in the present invention. Here, FIG. 1 shows only one light source substrate 4; however, actually, two or more light source substrates 4 are housed in the backlight chassis.

Besides, a reflection sheet 5 for reflecting light from the light source 3 to the front side is adhered to the front surface of the light source substrate 4. The reflection sheet 5 includes an opening for allowing the light source 3 to escape; the light source 3 mounted on the front surface of the light source substrate 4 protrudes toward the front side via the opening of the insulation sheet 5.

Besides, in a region that faces the front surface of the light source substrate 4 across a predetermined distance from the front surface, an optical sheet 6 into which the light from the light source 3 is input is disposed. And, diffusion and collection of the light from the light source 3 are performed by the optical sheet 6.

Here, in the first embodiment, a light-emitting device array, which includes: a light-emitting device 7 (hereinafter, called a light-emitting device 7a) that emits whitish yellow light; and a light-emitting device 7 (hereinafter, called a light-emitting device 7b) that emits blue light, is used as the light source 3. And, white light, which is obtained by the color mixing of the whitish yellow light emitted from the light-emitting device 7a and the blue light emitted from the light-emitting device 7b, is used as the illuminating light from the backlight unit 1. The light-emitting device 7a and the light-emitting device 7b are examples of a “first light-emitting device” and a “second light-emitting device” in the present invention, respectively.

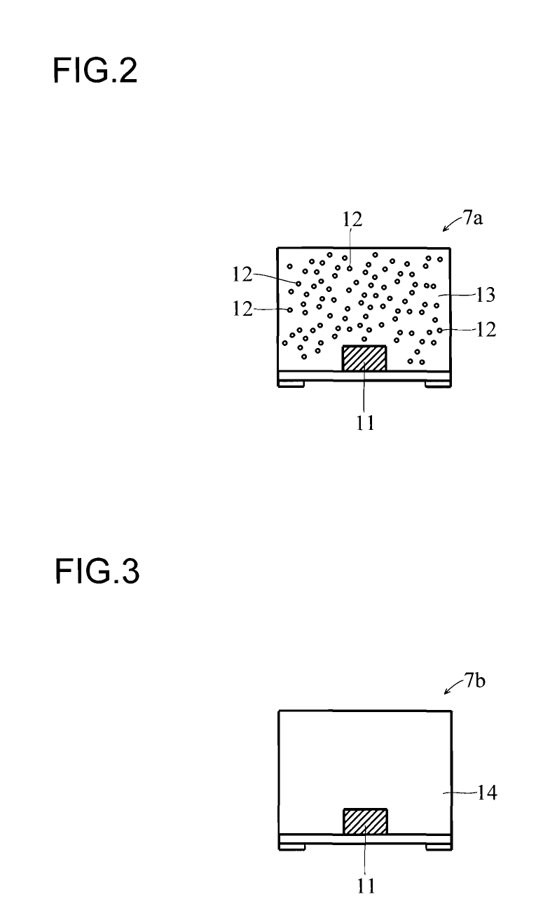

As shown in FIG. 2, the light-emitting device 7a that emits the whitish yellow light includes: a blue-light emitting diode element 11 that emits blue light, and a fluorescent material 12 that is excited by the blue light to emit yellow fluorescence; and has a structure in which the blue-light emitting diode element 11 is covered by a seal member 13 that contains the fluorescent material 12. In such a structure, when the blue-light emitting diode element 11 is driven, the blue light is emitted from the blue-light emitting diode element 11 and the yellow fluorescence is emitted from the fluorescent material 12 that absorbs the blue light. Accordingly, the color-mixed light (whitish yellow light) of the blue light and the yellow fluorescence is emitted from the light-emitting device 7a.

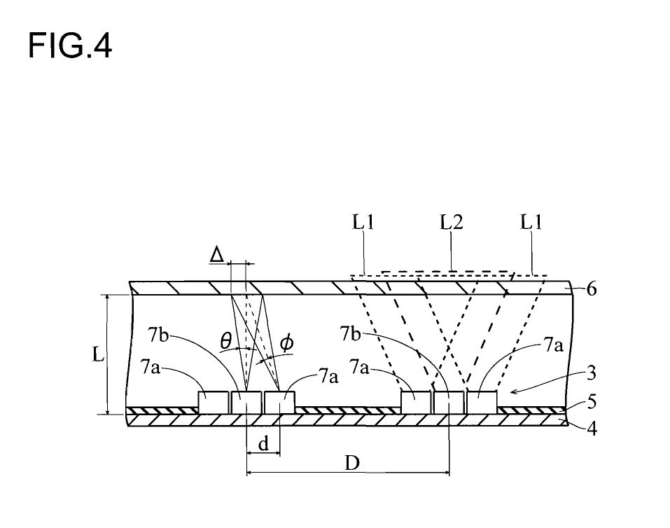

Besides, as shown in FIG. 3, the light-emitting device 7b that emits the blue light includes the blue-light emitting diode element 11 that has the same structure as the blue-light emitting diode element 11 of the light-emitting device 7a shown in FIG. 2; and has a structure in which the blue-light emitting diode element 11 is covered by a seal member 14 that does not contain the fluorescent material. Because of this, the blue light generated by the blue-light emitting diode element 11 is emitted from the light-emitting device 7b as it is.

Here, the blue, that is, the emitted-light color from the blue-light emitting diode element 11 shown in FIGS. 2 and 3 is one of three kinds of color obtained by roughly sorting visible light into the three kinds of color and is a general term of the color that includes purple, indigo blue and the like. In other words, the blue is a visible-light color that has a wavelength of 380 nm or longer to 500 nm or shorter.

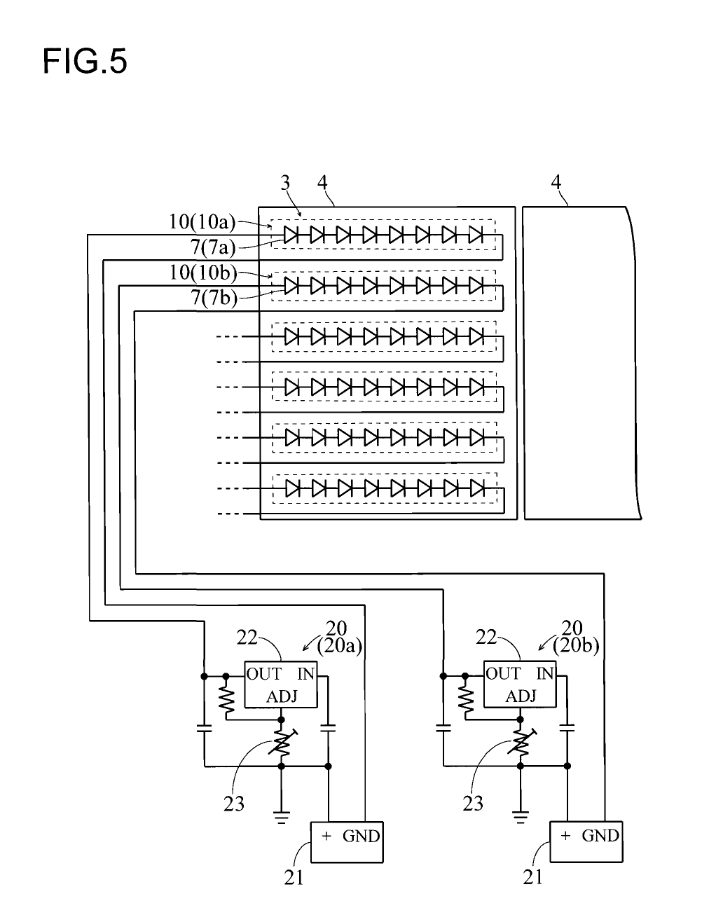

And, as shown in FIG. 4, the light-emitting devices 7a and 7b are disposed in such a way that light L1 and L2 respectively emitted from the light-emitting devices 7a and 7b color-mix with each other. Specifically, a number ratio of the light-emitting device 7a and 7b is 2:1 and one light-emitting device 7b is interposed between two light-emitting devices 7a in such a way that the light-emitting devices 7a and 7b come close to each other. In other words, the light-emitting device 7b is disposed close to each of the plurality of light-emitting devices 7a. Besides, when seen as a whole, as shown in FIG. 1, a plurality of light-emitting device lines 10 (hereinafter, called a light-emitting device line 10a), which each include a predetermined number of light-emitting devices 7a connected in series, are arranged in a stripe shape; and a plurality of light-emitting device lines 10b (hereinafter, called a light-emitting device line 10b), which each include a predetermined number of light-emitting devices 7b connected in series, are arranged in a stripe shape in such a way that each of the light-emitting device lines 10b is adjacent (close) to each of the plurality of light-emitting device lines 10a.

Besides, in the first embodiment, a light-source drive portion, which is able to adjust the light amounts (intensities) respectively emitted from the light-emitting devices 7a and 7b separately from each other, is connected to the light source 3. And, the light mounts respectively emitted from the light-emitting devices 7a and 7b are adjusted separately from each other, so that the illuminating light from the backlight unit 1 becomes a white color of a desired chromaticity.

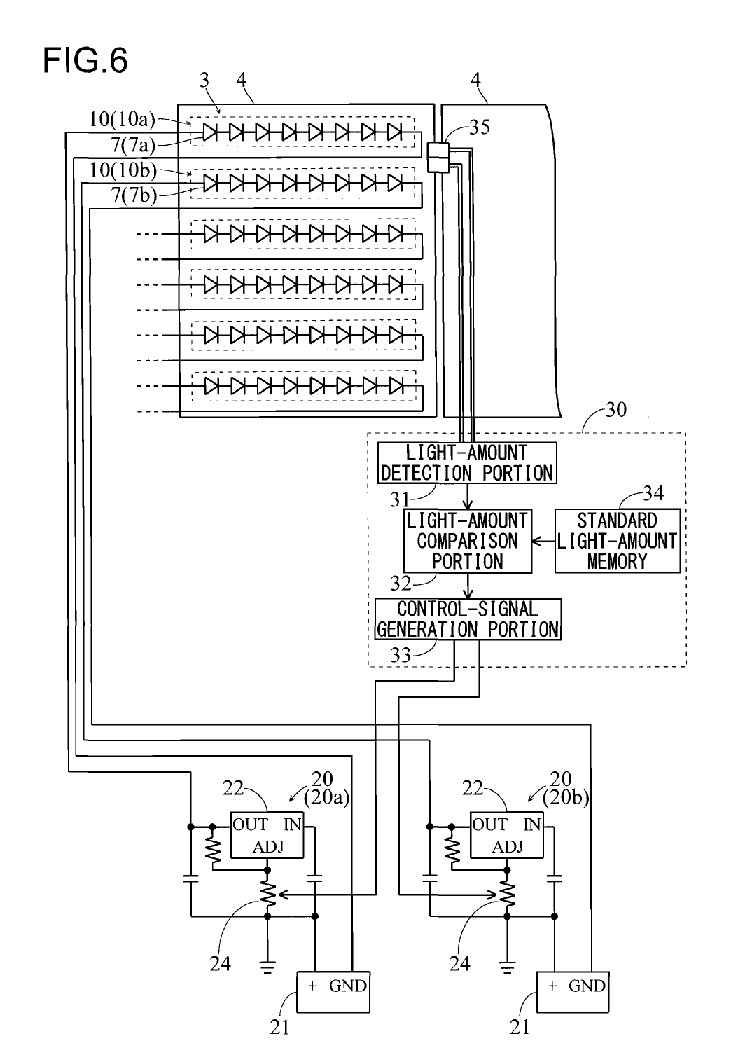

As shown in FIG. 5, the light-source drive portion in the first embodiment includes an electric-power supply portion 20 that supplies electric power to the light-emitting device lines 10 (light-emitting devices 7). And, the electric-power supply portion 20 is sorted into an electric-power supply portion 20a that supplies electric power to the light-emitting device line 10a (light-emitting devices 7a) and an electric-power supply portion 20b that supplies electric power to the light-emitting device line 10b (light-emitting devices 7b). In other words, one electric-power supply portion 20a is connected to each of the plurality of light-emitting device lines 10a; and one electric-power supply portion 20b is connected to each of the plurality of light-emitting device lines 10b. The electric-power supply portions 20a and 20b are examples of a “first electric-power supply portion” and a “second electric-power supply portion” in the present invention, respectively. Here, FIG. 5 shows only each one of the electric-power supply portions 20a and 20b for simplification of the drawing.

Besides, the electric-power supply portions 20a and 20b have the same circuit structure as each other and include a three-terminal regulator 22 and the like connected to a constant-voltage power supply 21. And, the light-emitting device line 10a (light-emitting devices 7a) are connected to an output terminal of the three-terminal regulator 22 of the electric-power supply portion 20a; and the light-emitting device line 10b (light-emitting devices 7b) are connected to an output terminal of the three-terminal regulator 22 of the electric-power supply portion 20b. And, a semi-fixed resistor 23 is connected to an ADJ terminal of each of the three-terminal regulators 22 of the electric-power supply portions 20a and 20b.

In the light-source drive portion in the first embodiment having the above structure, the output electric power from the electric-power supply portion 20 (three-terminal regulator 22) becomes an electric power corresponding to a value of the semi-fixed resistor 23 of the electric-power supply portion 20. In other words, the value of the semi-fixed resistor 23 of the electric-power supply portion 20a is changed, so that the electric power supplied to the light-emitting device line 10a (light-emitting devices 7a) is independently adjusted; the value of the semi-fixed resistor 23 of the electric-power supply portion 20b is changed, so that the electric power supplied to the light-emitting device line 10b (light-emitting devices 7b) is independently adjusted. Accordingly, so that the light amount emitted from each of the light-emitting devices 7a and 7b becomes an appropriate light amount to obtain the white light of a predetermined chromaticity, it becomes possible to adjust the light amounts respectively emitted from the light-emitting devices 7a and 7b separately from each other for every light-emitting device line 10. Here, in this case, the light-amount adjustment is performed in a production time.

In the first embodiment, as described above, the light-emitting device 7a that emits the whitish yellow light and the light-emitting device 7b that emits the blue light are mounted on the front surface of the light source substrate 4; the light-emitting device 7b is disposed close to the light-emitting device 7a in such a way that both light respectively emitted from the light-emitting devices 7a and 7b color-mix with each other; because of this, in the illuminating operation, because the light (whitish yellow light) emitted from the light-emitting device 7a color-mixes with the light (blue light) emitted from the light-emitting device 7b, the color-mixed light of both light respectively emitted from the light-emitting devices 7a and 7b serves as the illuminating light from the backlight unit 1. In this case, if the light amounts respectively emitted from the light-emitting device 7a and 7b are adjusted separately from each other, it is possible to turn the illuminating light (color-mixed light of both light respectively emitted from the light-emitting devices 7a and 7b) from the backlight unit 1 into the white color of the desired chromaticity. As a result of this, it becomes possible to prevent color unevenness from occurring in the illuminating light (white light) from the backlight unit 1.

Besides, in the structure according to the first embodiment, because it is not necessary to use a red-light emitting diode element and a green-light emitting diode element, it is also possible to prevent a disadvantage that the production cost increases from occurring.

Besides, in the first embodiment, as described above, by disposing the light-emitting device 7b close to each of the plurality of light-emitting devices 7a, it is possible to surely make both light respectively emitted from the light-emitting devices 7a and 7b color-mix with each other.

Besides, in the first embodiment, as described above, because the light-emitting devices 7a and 7b have the structures shown in FIGS. 2 and 3, even if the two kinds of light-emitting devices (light-emitting devices 7a and 7b) are used, the blue-light emitting diode elements 11 mounted in the light-emitting devices 7a and 7b are the same as each other, so that it is possible to further prevent the production cost from increasing.

In this case, the number ratio of the light-emitting device 7a and the light-emitting device 7b is 2:1 and one light-emitting device 7b is interposed between two light-emitting devices 7a in such a way that the light-emitting devices 7a and 7b come close to each other, so that it is possible to improve the balance between the light amounts respectively emitted from the light-emitting devices 7a and 7b.

As described above, if the number ratio of the light-emitting device 7a and the light-emitting device 7b is 2:1, a light-amount balance that gives a white color is obtained as a whole; however, to obtain even color mixing to prevent color unevenness from occurring on the illuminating surface (optical sheet 6), it is necessary to set the between-center distance between the light-emitting devices 7a and 7b based on a predetermined condition. Hereinafter, a method for setting the between-center distance between the light-emitting devices 7a and 7b is described with reference to FIG. 4. Here, in the following description, the between-center distance between the light-emitting devices 7a and 7b is d, and the distance between the light source substrate 4 and the optical sheet 6 is L.

Specifically, as shown in FIG. 4, the light is emitted from each of the light-emitting devices 7a and 7b with an angle characteristic in accordance with Lambert scattering. Because of this, the light amount that is emitted from the light-emitting device 7b and reaches a predetermined region (width A) of the optical sheet 6 depends on the following formula (1); the light amount that is emitted from the light-emitting device 7a and reaches a predetermined region (width Δ) of the optical sheet 6 depends on the following formula (2).

2×∫ cos θdθ (integration interval:0 to tan⁻¹(Δ/L)) (1)

2×∫ cos φdφ (integration interval:tan⁻¹ ((d−Δ)/L) to tan⁻¹(d/L)) (2)

Accordingly, the following formulas (1′) and (2′) are obtained. Here, in the following formulas, d/L=α.

Δ/√(L²+Δ²) (1′)

α(1−(Δ/d)²)/√(1+α²) (2′)

Here, the inventor of the present application has the knowledge that if a difference between the light amounts respectively emitted from the light-emitting devices 7a and 7b is 1% or lower, it is possible to prevent color unevenness from occurring. Specifically, to obtain even color mixing to prevent color unevenness from occurring on the illuminating surface (optical sheet 6), it is sufficient to set the between-center distance d between the light-emitting devices 7a and 7b based on the following formula (3).

[α(1−(Δ/d)²)/√(1+α²)]/[Δ/√(L²+Δ²)]>0.99 (3)

Here, because Δ is a minuscule region, if the second- and higher-degree terms of Δ are ignored and calculated, the above formula (3) approximately becomes the following formula (3′).

1/√(1+α²)<0.99 (3′)

Therefore, because α<0.14, if α=d/L is assigned, d<0.14 L. As a result of this, it is sufficient to set the between-center distance d between the light-emitting devices 7a and 7b in such a way that d<0.14 L is met.

Because of this, in the first embodiment, to meet the above condition, the between-center distance d between the light-emitting devices 7a and 7b is set at about 3 mm; and the distance L between the light source substrate 4 and the optical sheet 6 is set at about 24 mm. Besides, the distance D between the adjacent light-emitting devices 7b of each of the adjacent light-emitting device groups (the group that includes the two light-emitting devices 7a and the one light-emitting device 7b) is set at about 20 mm. Here, in a direction perpendicular to the paper surface as well, the distance D is set at about 20 mm. In other words, the plurality of groups of light-emitting devices are arranged squarely.

Besides, in the first embodiment, as described above, it is possible to separately adjust the respective output electric powers from the electric-power supply portion 20a that supplies electric power to the light-emitting device 7a and the from the electric-power supply portion 20b that supplies electric power to the light-emitting device 7b, so that it is possible to easily adjust the light amounts respectively emitted from the light-emitting devices 7a and 7b separately from each other.

### Second Embodiment

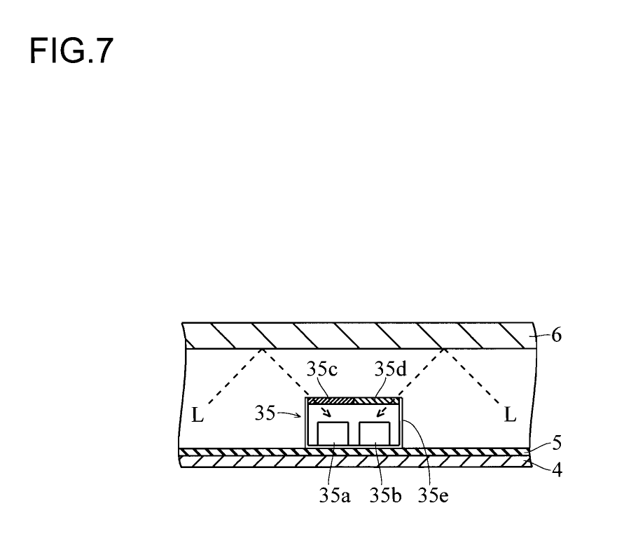

Next, a light-source drive portion of a backlight unit according to a second embodiment is described with reference to FIGS. 6 and 7.

In the light-source drive portion in the second embodiment, as shown in FIG. 6, in the structure of the light-source drive portion in the first embodiment shown in FIG. 5, instead of the semi-fixed resistor, a variable resister 24 is connected to the ADJ terminal of each of the three-terminal regulators 22 of the electric-power supply portions 20a and 20b.

Besides, in the light-source drive portion in the second embodiment, in the structure of the light-source drive portion in the first embodiment shown in FIG. 5, besides the electric-power supply portions 20a and 20b, a feedback portion 30 is further disposed. The feedback portion 30 is provided with: a light-amount detection portion 31; a light-amount comparison portion 32; a control-signal generation portion 33; and a standard light-amount memory 34.

The light-amount detection portion 31 detects the light amounts (intensity) respectively emitted from the light-emitting devices 7a and 7b; and is connected to a light-receiving portion 35 that is disposed on a border portion between adjacent light source substrates 4. Here, a plurality of the light-receiving portions 35 are disposed in the region where the light source substrate 4 is housed.

Besides, as shown in FIG. 7, the light-receiving portion 35 connected to the light-amount detection portion 31 includes: light-receiving elements 35a and 35b; and color filters 35c and 35d. The color filter 35c transmits yellow light (yellow fluorescence) only and covers a light-receiving surface of the light-receiving element 35a. The color filter 35d transmits blue light only and covers a light-receiving surface of the light-receiving element 35b. Here, around the light-receiving elements 35a and 35b, to prevent the light that does not pass through the color filters 35c and 35d from entering the light-receiving elements 35a and 35b, a resin cover 35e for blocking light is disposed. Because of this, the light-receiving element 35a detects only the light amount of yellow fluorescence that passes through the color filter 35c; and the light-receiving element 35b detects only the light amount of blue light that passes through the color filter 35d. Here, arrows L shown in FIG. 7 represent both light respectively emitted from the light-emitting devices 7a and 7b (see FIG. 6). And, as shown in FIG. 6, the detection value detected by the light-amount detection portion 31 (light-receiving portion 35) is output to the light-amount comparison portion 32.

The light-amount comparison portion 32 compares the detection value (the light amount actually emitted from each of the light-emitting devices 7a and 7b) that is detected by the light-amount detection portion 31 with an appropriate value (appropriate light amount to obtain the white light of a predetermined chromaticity) that is stored in the standard light-amount memory 34; and based on the comparison result, obtains a correction value corresponding to each of the light-emitting devices 7a and 7b. Here, each correction value obtained by the light-amount comparison portion 32 is a value to correct the light amount actually emitted from each of the light-emitting devices 7a and 7b into an appropriate value. And, each correction value obtained by the light-amount comparison portion 32 is output to the control-signal generation portion 33.

Based on each correction value obtained by the light-amount comparison portion 32, the control-signal generation portion 33 changes separately the values of the respective variable resistors 24 of the electric-power supply portions 20a and 20b. Specifically, the control-signal generation portion 33 is connected to the respective variable resistors 24 of the electric-power supply portions 20a and 20b; outputs the correction value corresponding to the light-emitting device 7a to the variable resistor 24 of the electric-power supply portion 20a; and outputs the correction value corresponding to the light-emitting device 7b to the variable resistor 24 of the electric-power supply portion 20b.

The other structures of the second embodiment are the same as the first embodiment.

In the light-source drive portion in the second embodiment having the above structure, the light amount emitted from each of the light-emitting devices 7a and 7b is adjusted as described below.

Specifically, during a time the illuminating operation for the liquid crystal display panel is performed, the light amounts respectively emitted from the light-emitting devices 7a and 7b are detected by the light-amount detection portion 31 (light-receiving portion 35) at the same time; and the detection values are output to the light-amount comparison portion 32.

Thereafter, comparison of the detection value (light amount actually emitted from each of the light-emitting devices 7a and 7b) detected by the light-amount detection portion 31 with the appropriate value (appropriate light amount to obtain the white light of a predetermined chromaticity) that is stored in the standard light-amount memory 34 is performed by the light-amount comparison portion 32; based on the comparison result, each correction value is obtained to correct the light amount emitted from each of the light-emitting devices 7a and 7b into the appropriate value. Besides, each correction value obtained by the light-amount comparison portion 32 is output to the control-signal generation portion 33.

Next, the correction value corresponding to the light-emitting device 7a is output to the variable resistor 24 of the electric-power supply portion 20a by the control-signal generation portion 33; and the correction value corresponding to the light-emitting device 7b is output to the variable resistor 24 of the electric-power supply portion 20b by the control-signal generation portion 33. In this way, based on the corresponding correction values, the values of the respective variable resistors 24 of the electric-power supply portions 20a and 20b separately change; and the respective output electric powers from the electric-power supply portions 20a and 20b are separately adjusted. As a result of this, the light amounts respectively emitted from the light-emitting devices 7a and 7b are adjusted separately from each other for every light-emitting device line 10 in such a way that the light amount emitted from each of the light-emitting devices 7a and 7b becomes the appropriate light amount to obtain the white light of the predetermined chromaticity.

In the second embodiment, according the above structure, even if the chromaticity of the light emitted from each of the light-emitting devices 7a and 7b changes with time, it is possible to adjust the light amounts respectively emitted from the light-emitting devices 7a and 7b separately from each other in accordance with the change. Accordingly, it becomes possible to perform a strict light-amount adjustment. Besides, in this case, the light-amount adjustment at a production time becomes unnecessary.

The other effects of the second embodiment are the same as the first embodiment.

### Third Embodiment

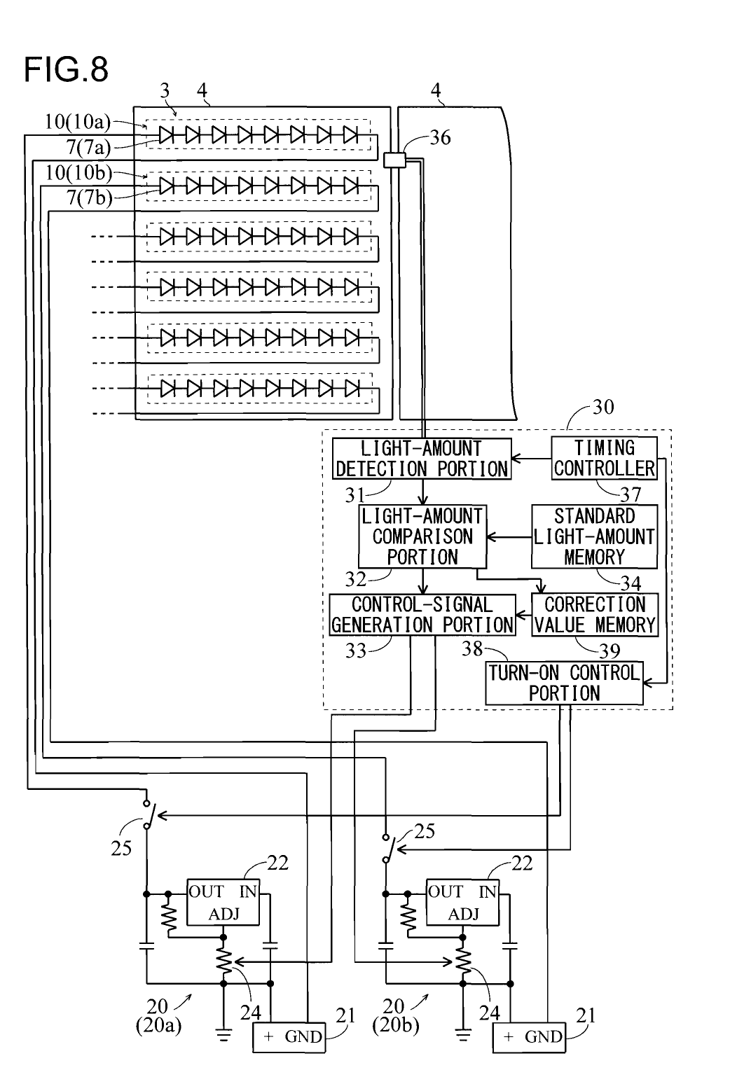

Next, a light-source drive portion of a backlight unit according to a third embodiment is described with reference to FIG. 8.

In the light-source drive portion in the third embodiment, as shown in FIG. 8, in the structure of the light-source drive portion in the second embodiment shown in FIG. 6, a switch 25 is connected to the output side (between the output terminal of the three-terminal regulator 22 and the light-emitting device lines 10a and 10b) of each of the electric-power supply portions 20a and 20b. In other words, it is possible to select a predetermined light-emitting device line 10 from the plurality of light-emitting device lines 10 and turn on the light-emitting devices 7 only of the selected light-emitting device line 10.

Besides, in the light-source drive portion in the third embodiment, in the structure of the light-source drive portion in the second embodiment shown in FIG. 6, instead of the light-receiving portion that includes two light-receiving elements and two color filters, a light-receiving portion 36 that includes only one light-receiving element is connected to the light-amount detection portion 31 of the feedback portion 30. Here, only one light-receiving portion 36 is disposed in the region where the light source substrate 4 is housed. Besides, the feedback portion 30 is further provided with: a timing controller 37; a turn-on control portion 38; and a correction value memory 39 besides the light-amount detection portion 31, the light-amount comparison portion 32, the control-signal generation portion 33 and the standard light-amount memory 34.

The timing controller 37 selects a predetermined light-emitting device line 10 from the plurality of light-emitting device lines 10; and outputs the information to the light-amount detection portion 31 and the turn-on control portion 38. Based on the information from the timing controller 37, the turn-on control portion 38 turns on the switch 25 of a predetermined electric-power supply portion 20 that is connected to the selected light-emitting device line 10; and turns off the other switch 25. The correction value memory 39 temporarily stores each correction value obtained by the light-amount comparison portion 32.

The other structures of the third embodiment are the same as the second embodiment.

In the light-source drive portion in the third embodiment having the above structure, the light amount emitted from each of the light-emitting devices 7a and 7b is adjusted as described below.

Specifically, first, if a turning-off operation of the backlight unit is performed, the entire display surface of the liquid crystal display panel is displayed black.

In the state, a predetermined light-emitting device line 10 is selected from the plurality of light-emitting device lines 10 by the timing controller 37 and the information is output to the light-amount detection portion 31 and the turn-on control portion 38. Because of this, only the switch 25 of a predetermined electric-power supply portion 20 connected to the selected light-emitting device line 10 is turned on and the other switch 25 is turned off. In this way, light is emitted from only the light-emitting devices 7 of the selected light-emitting device line 10 and light is not emitted from the other light-emitting devices 7. Accordingly, only the light amount emitted from the light-emitting devices 7 of the selected light-emitting device line 10 is detected by the light-amount detection portion 31 (light-receiving portion 36); and the detection value is output to the light-amount comparison portion 32.

Thereafter, comparison of the detection value (light amount actually emitted from the light-emitting devices 7 of the selected light-emitting device line 10) detected by the light-amount detection portion 31 with the appropriate value (appropriate light amount to obtain the white light of a predetermine chromaticity) that is stored in the standard light-amount memory 34 is performed by the light-amount comparison portion 32; based on the comparison result, the correction value is obtained to correct the light amount emitted from the light-emitting devices 7 of the selected light-emitting device line 10 into the appropriate value. Besides, the correction value obtained by the light-amount comparison portion 32 is stored into the correction value memory 39.

Thereafter, as for the light-emitting devices 7 of the remaining light-emitting device lines 10 as well, a correction value is obtained for every light-emitting device line 10. And, each correction value is stored into the correction value memory 39.

Next, each correction value stored in the correction value memory 39 is read by the control-signal generation portion 33 and output to the respective variable resistors 24 of the plurality of electric-power supply portions 20 by the control-signal generation portion 33. In this way, based on the corresponding correction values, the values of the respective variable resistors 24 of the plurality of electric-power supply portions 20 separately change; and the respective output electric powers from the plurality of electric-power supply portions 20 are separately adjusted. As a result of this, the light amounts respectively emitted from the light-emitting devices 7a and 7b are adjusted separately from each other for every light-emitting device line 10 in such a way that the light amount emitted from each of the light-emitting devices 7a and 7b becomes the appropriate light amount to obtain the white light of the predetermined chromaticity. Here, in this case, it is preferable that the light-amount adjustment is started immediately after the power supply of the device is turned off. This is because immediately after the power supply of the device is turned off, the internal temperature distribution of the backlight unit comes close to an actual use condition.

In the third embodiment, according the above structure, even if the chromaticity of the light emitted from each of the light-emitting devices 7a and 7b changes with time, it is possible to adjust the light amounts respectively emitted from the light-emitting devices 7a and 7b separately from each other in accordance with the change. Accordingly, it is possible to perform a strict light-amount adjustment. Besides, in this case, the light-amount adjustment at a production time becomes unnecessary.

Besides, in the third embodiment, according to the above structure, in detecting the light amount emitted from the light-emitting devices 7 of the predetermined light-emitting device line 10, it is possible to remove the influence of stray light, that is, disturbance light from other light-emitting devices 7. In this way, because it is possible to capture a correct light amount for every light-emitting device line 10, it becomes possible to perform a stricter light-amount adjustment.

Besides, in the third embodiment, according to the above structure, it is possible to reduce the number of light-receiving elements connected to the light-amount detection portion 31. Specifically, for one backlight unit, it is possible to reduce the number of light-receiving elements, which are connected to the light-amount detection portion 31, to one.

The other effects of the third embodiment are the same as the first embodiment.

It should be considered that the embodiments disclosed this time are examples in all respects and not limiting. The scope of the present invention is not indicated by the above description of the embodiments but by the claims, and moreover, all modifications within the scope of the claims and the meaning equivalent to the claims are covered.

For example, in the above embodiments, the example, in which the present invention is applied to a backlight unit disposed in a liquid crystal display device, is described; however, the present invention is not limited to this, and also applicable to a backlight unit disposed in a display device other than a liquid crystal display device. Moreover, the present invention is applicable to an illuminating device other than a backlight unit.

Besides, in the above embodiments, the example, in which the present invention is applied to a direct-type backlight unit, is described; however, the present invention is not limited to this, and also applicable to an edge- light type backlight unit. Here, in an edge-type backlight unit, a light guide plate is disposed on a rear-surface side of a liquid crystal display panel; a light source is so disposed as to face a predetermined end surface of the light guide plate; and the rear surface of the liquid crystal display panel is irradiated with light emitted from the light source via the light guide plate.

Besides, in the above embodiments, as the light-emitting device that emits whitish yellow light, a light-emitting device, in which a blue-light emitting diode element is covered by a fluorescent material that emits yellow fluorescence, is used; however, the present invention is not limited to this, and a light-emitting device, in which a blue-light emitting diode element is covered by a fluorescent material that emits red fluorescence and by a fluorescent material that emits green fluorescence, may be used.

1. An illuminating device comprising:
a support member; and
a first light-emitting device that is disposed on a predetermined surface of the support member; includes: a blue-light emitting diode element that emits blue light, and a fluorescent material that absorbs the blue light and emits fluorescence; and emits color-mixed light of the blue light and the fluorescence;
wherein besides the first light-emitting device, a second light-emitting device that emits blue light is disposed on the predetermined surface of the support member; and
the first light-emitting device and the second light-emitting device are disposed in such a way that the light emitted from the first light-emitting device and the light emitted from the second light-emitting device color-mix with each other.

2. The illuminating device according to claim 1, wherein the second light-emitting device is disposed close to each of a plurality of the first light-emitting devices.

3. The illuminating device according to claim 1, wherein the second light-emitting device includes a blue-light emitting diode element that has the same structure as the blue-light emitting diode element of the first light-emitting device and emits blue light generated by the blue-light emitting diode element.

4. The illuminating device according to claim 3, wherein the second light-emitting device is disposed at a ratio of one second light-emitting device to two first light-emitting devices.

5. The illuminating device according to claim 1, wherein light amounts respectively emitted from the first light-emitting device and the second light-emitting device are adjusted separately from each other.

6. The illuminating device according to claim 5, further comprising: a first electric-power supply portion that supplies electric power to the first light-emitting device and a second electric-power supply portion that supplies electric power to the second light-emitting device;
wherein respective output electric powers from the first electric-power supply portion and the second electric-power supply portion are adjusted separately from each other.

7. The illuminating device according to claim 6, further comprising a light-amount detection portion that detects a light amount emitted from each of the first light-emitting device and the second light-emitting device;
wherein based on a detection result in the light-amount detection portion, the respective light amounts from the first electric-power supply portion and the second electric-power supply portion are separately adjusted.

8. A display device comprising:
the illuminating device described in claim 1; and
a display panel which is irradiated with light emitted from the illuminating device.

9. A display device comprising:
the illuminating device described in claim 2; and
a display panel which is irradiated with light emitted from the illuminating device.

10. A display device comprising:
the illuminating device described in claim 3; and
a display panel which is irradiated with light emitted from the illuminating device.

11. A display device comprising:
the illuminating device described in claim 4; and
a display panel which is irradiated with light emitted from the illuminating device.

12. A display device comprising:
the illuminating device described in claim 5; and
a display panel which is irradiated with light emitted from the illuminating device.

13. A display device comprising:
the illuminating device described in claim 6; and
a display panel which is irradiated with light emitted from the illuminating device.

14. A display device comprising:
the illuminating device described in claim 7; and
a display panel which is irradiated with light emitted from the illuminating device.
